(19) United States
(12) Patent Application Publication
(10) Pub. No.: US 2015/0029149 A1
(43) Pub. Date: Jan. 29, 2015

(54) Apparatus and Method for Navigating on a Touch Sensitive Screen Thereof

(71) Applicants: Ola Andersson, Sao Paolo (BR); Robert Skog, Hässelby (SE)

(72) Inventors: Ola Andersson, Sao Paolo (BR); Robert Skog, Hässelby (SE)

(73) Assignee: Telefonaktiebolaget L M Ericsson (publ), Stockholm (SE)

(21) Appl. No.: 14/383,918

(22) PCT Filed: Mar. 13, 2012
(86) PCT No.: PCT/EP2012/054334

§ 371 Date: Sep. 9, 2014

(51) Int. Cl. G06F 3/041

(52) U.S. Cl. CPC G06F 3/0414
USPC 345/174

(57) ABSTRACT

The present invention relates to a method and apparatus (100), such as a portable electronic device, for navigating on a touch sensitive screen (110) of the apparatus (100). The method comprises sensing the amount of pressure exerted on the touch sensitive screen (100) by means of a pressure sensor (140). A pressure signal indicative of the exerted amount of pressure is generated. The pressure signal is then used to trigger navigation in a z-direction, i.e. a direction perpendicular to the plane of the touch sensitive screen if the pressure signal is above a predetermined threshold.

### TECHNICAL FIELD

Embodiments of the present invention presented herein generally relate to user interface technology. More specifically, embodiments of the present invention relate to methods, apparatuses, computer programs and computer program products for facilitating interaction with apparatuses comprising a touch sensitive screen.

### BACKGROUND

Modern communication technology and modern computing technology has led to a new generation of apparatuses. Some apparatuses that are ubiquitous today have a small form factor and are used for execution of a wide range of applications. Examples of such apparatuses are portable electronic devices. Portable electronic devices include, but are not limited to, mobile telephones (sometimes also referred to as mobile phones, cell phones, cellular telephones, smart phones and the like) and tablet computers.

Traditionally, various user interfaces including for example mouse pointers, left and right mouse buttons, scroll wheels, keyboard scroll keys etc. were used to provide a way for users to interact with the apparatuses. However, as apparatuses become more compact, and the number of functions or applications performed by a given apparatus increases, it has become a challenge to design a user interface that allows users to easily interact with a multifunction apparatus. This challenge is especially significant for handheld portable electronic devices, which generally have comparatively smaller displays or screens than e.g. desktop or laptop computers. The form factor together with a more advanced computing technology has therefore given rise to new apparatuses for allowing user interaction. One such apparatus that is becoming increasingly popular is the touch sensitive screen apparatus, i.e. an apparatus comprising a touch sensitive screen. Touch sensitive screens allow users to interact with and send commands to an apparatus by touching an input object to the surface of the touch sensitive screen.

Touch sensitive screens are attractive, e.g., because they facilitate small form factor apparatuses (e.g. mobile telephones or tablet computers) on which there may be limited room to include a display as well as one or several key buttons, scroll wheels, and/or the like for allowing the user to interact with and send commands to an apparatus. Also, inputting commands to an apparatus by touching a graphical user interface displayed on a touch sensitive screen may be very intuitive to some users, and thus touch sensitive screens are generally perceived as user-friendly by many users. Navigating on a touch sensitive screen is typically based on a “multipage” concept, where multiple pages are situated next to each other in a two dimensional XY-plane in either a grid, i.e. a×b pages, or in a one row sequence, i.e. 1×n pages. The user sees one page at the time on the screen and navigates between the pages in the XY-plane by touch-drag, i.e. flicking, on the screen in the corresponding direction.

As the number of functions or applications in the apparatuses increases, as mentioned above, several applications, different view pages, different folders etc. are blended in the graphical user interface, i.e. the touch sensitive screen. Having many services and views on the same apparatus will make the navigation thereon time-consuming and sometimes also somewhat confusing for a user. When the user tries to reach a specific destination or “points of interest” he or she may loose track of which view or level he or she presently navigates on.

In order to address this issue, and allow users quick access to both the most popular features and the most interesting items or “objects of interest”, many systems offer a dashboard type of application which allows the user to add shortcuts to specific applications and/or views within specific applications. An example of this is creating a direct access to a specific web page within a browser application.

One problem with existing solutions is that the user is forced to a process containing many steps when for example adding a destination to the dashboard. The steps typically contain selecting a program icon, invoking a context menu and selecting “Add to Home screen”.

### SUMMARY

It is in view of the above considerations and others that the various embodiments of the present invention have been made. The inventors have realized that, even if touch sensitive screens of today are generally perceived as providing effective and user-friendly interaction experiences, there is still a need for further improving or facilitating the interaction with apparatuses having a touch sensitive screen, i.e. touch sensitive screen apparatuses.

In view of the above, it is therefore a general object of the various embodiments of the present invention to facilitate the interaction with an apparatus comprising a touch sensitive screen.

The various embodiments of the present invention as set forth in the appended claims address this general object.

According to a first aspect, there is provided a method for navigating on a touch sensitive screen of an apparatus. The method comprises the steps of sensing the amount of pressure exerted on the touch sensitive screen and generating a pressure signal indicative of the exerted amount of pressure. The pressure signal is then used to trigger navigation in a z-direction, i.e. a direction perpendicular to the plane of the touch sensitive screen if the pressure signal is above a predetermined threshold.

The method may further comprise the step of moving an object of interest, on which the pressure above the predetermined pressure is exerted, into the z-direction. In a preferred embodiment triggering navigation in the z-direction is only made if the pressure signal is above the predetermined threshold during a time period that is longer than a predetermined time. The amount of time the pressure signal has been above the predetermined threshold may also trigger the depth of the navigation in the z-direction. Furthermore, the amount of pressure exerted on the touch sensitive screen may also control the speed of the navigation in the z-direction, i.e. a harder exerted pressure gives faster navigation.

In a preferred embodiment of the present invention a display area of the touch sensitive screen is divided into multiple sections in response to the navigation in the z-direction, each section representing a function or application performable by the apparatus.

According to a second aspect, there is provided an apparatus, such as a portable electronic device (e.g., a mobile telephone or a tablet computer). The apparatus comprises a touch sensitive screen having a display area, a pressure sensor, a processor and a memory for storing a computer program comprising computer program code. When the computer program code is run in the processor it causes the apparatus to sense the amount of pressure exerted on the touch sensitive screen and generate a pressure signal in response to sensed pressure. The apparatus is then caused to trigger navigation in a z-direction, i.e. in a direction perpendicular to the plane of the touch sensitive screen if the pressure signal is above a predetermined threshold.

The apparatus according to the present invention may further be configured to cause an object of interest to be moved into the z-direction if the pressure exerted on the touch sensitive screen was exerted on the object of interest.

In a preferred embodiment the memory and the computer program run in the processor are configured to further cause the apparatus to trigger navigation in the z-direction only if the pressure signal is above the predetermined threshold during a time period that is longer than a predetermined time. Furthermore the memory and the computer program run in the processor are configured to further cause the apparatus to control the depth of the navigation in the z-direction in response to the amount of time the pressure signal has been above the predetermined threshold and control the speed of navigation in the z-direction in response to the amount of pressure exerted on the touch sensitive screen.

In yet another preferred embodiment the memory and the computer program run in the processor are configured to cause the apparatus to divide a display area of the touch sensitive screen into multiple sections in response to the navigation in the z-direction, said sections each representing a function or application performable by the apparatus.

According to a third aspect, there is provided a computer program. The computer program comprises computer program code which, when run in a processor of an apparatus, causes the apparatus to perform the method according to the first aspect mentioned above.

According to a fourth aspect, there is provided a computer program product. The computer program product may comprise computer program according to the third aspect and a computer readable means on which the computer program is stored.

Various aspects and embodiments of the present invention provide for facilitated interaction with apparatuses having touch sensitive screens. By triggering navigation in a z-direction, i.e. a direction perpendicular to the plane of the touch sensitive screen it will be much easier and faster for a user to reach and navigate on the touch sensitive screen.

### BRIEF DESCRIPTION OF THE DRAWINGS

These and other aspects, features and advantages of the invention will be apparent and elucidated from the following description of embodiments of the present invention, reference being made to the accompanying drawings, in which:

FIG. 1 is a block diagram illustrating some modules of an embodiment of an apparatus comprising a touch sensitive screen;

FIG. 2 illustrates an apparatus in form of a mobile telephone having a touch sensitive screen according to an example embodiment of the invention;

FIG. 3a-3e illustrates different views during navigation among different contents displayed on a touch sensitive screen according to an embodiment of the invention;

FIG. 4 is a flow chart illustrating a method performed by an apparatus according to an embodiment of the invention; and

FIG. 5 schematically shows one example of a computer program product comprising computer readable means.

### DETAILED DESCRIPTION

The invention will now be described more fully hereinafter with reference to the accompanying drawings, in which certain embodiments of the invention are shown. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like numbers refer to like elements throughout the description.

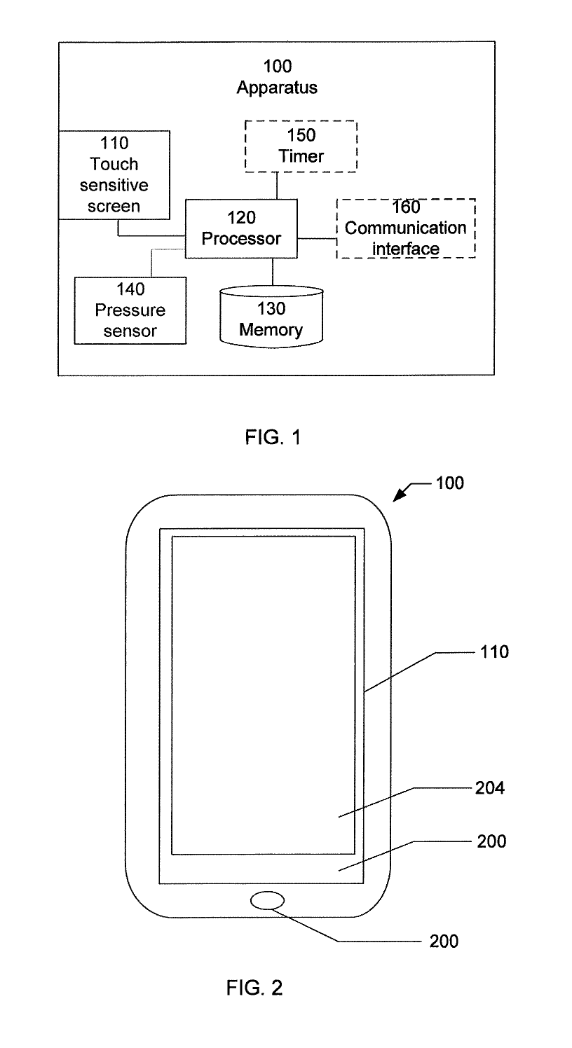

FIG. 1 illustrates a block diagram of an apparatus 100 according to an example embodiment of the present invention. The apparatus 100 may be embodied as any device comprising a touch sensitive screen 110. Thus, the apparatus 100 may also be referred to as a touch screen apparatus. While FIG. 1 illustrates one example of a configuration of a touch screen apparatus, numerous other configurations may also be used to implement embodiments of the present invention.

The apparatus 100 may be embodied as a portable electronic device. Examples of portable electronic devices include, but are not limited to, mobile telephones (sometimes also referred to as mobile phones, cell phones, cellular telephones, smart phones and the like), mobile communication devices, tablet computers, etc.

The apparatus 100 illustrated in FIG. 1 comprises a touch sensitive screen 110, a processor 120, a memory 130 and a pressure sensor 140. Optionally the apparatus 100 may also comprise a timer 150 and communication interface 160. The touch sensitive screen 110 may be in communication with the processor 120, the memory 130, the pressure sensor 140, the timer 150 and/or the communication interface 160, such as via a bus.

The touch sensitive screen 110 may comprise any known touch sensitive screen that may be configured to enable touch recognition by any suitable technique, such as, for example, capacitive, resistive, infrared, strain gauge, surface wave, optical imaging, dispersive signal technology, acoustic pulse recognition, and/or other suitable touch recognition techniques. Accordingly, the touch sensitive screen 110 may be operable to be in communication with the processor 120 to receive an indication of a user input in the form of a touch interaction, e.g., a contact between the touch sensitive screen 110 and an input object (e.g., a finger, stylus, pen, pencil, and/or the like).

The processor 120 may be provided using any suitable central processing unit (CPU), microcontroller, digital signal processor (DSP), etc., capable of executing computer program comprising computer program code, the computer program being stored in the memory 130. The memory 130 may be any combination of random access memory (RAM) and read only memory (ROM). The memory may also comprise persistent storage, which, for example, can be any single one or combination of magnetic memory, optical memory, or solid state memory or even remotely mounted memory.

The pressure sensor 140 is preferably placed under the touch sensitive screen 110 such that the pressure sensor 140 will sense how much pressure that is exerted on the touch sensitive screen 110. Depending on the type of touch sensitive screen 110 that is used one or more pressure sensors 140 may be needed in order to sense the pressure accurately. Thus, in the context of the present invention the term pressure sensor 140 may include one or more sensors. There are many types of pressure sensors 140, measuring pressure either directly or indirectly, that may be used together with the present invention as is readily understood by a person skilled in the art. For example strain gauges may be used or the pressure may also be obtained indirectly by analyzing the touch area, i.e. the area of the screen that is covered by a finger when the screen is touched. A large area would then indicate a hard press.

The timer 150 may be used to measure the time the user interacts with the touch sensitive screen 110. In other words by using the timer 150 it is possible for the apparatus 100 to distinguish between a “short” or a “long” touch by a user and thereby use this as a criteria to trigger different events depending on the measured time. Even though the timer 150 in FIG. 1 is embodied as a separate unit it should be appreciated that a timer function may be embodied as any device or means embodied in circuitry, hardware, a computer program product comprising computer readable program code stored on a computer readable medium (e.g., the memory 130) and executed by a processing device (e.g., the processor 120), or a combination thereof that is configured to provide the timer function.

The communication interface 160 may be used to connect the apparatus 100 to a communications network. The communications network may e.g. be complying with any or a combination of UMTS (Universal Mobile Telecommunications System), CDMA2000 (Code Division Multiple Access 2000), LTE (Long Term Evolution), GSM (Global System for Mobile Communications), WLAN (Wireless Local Area Network), etc.

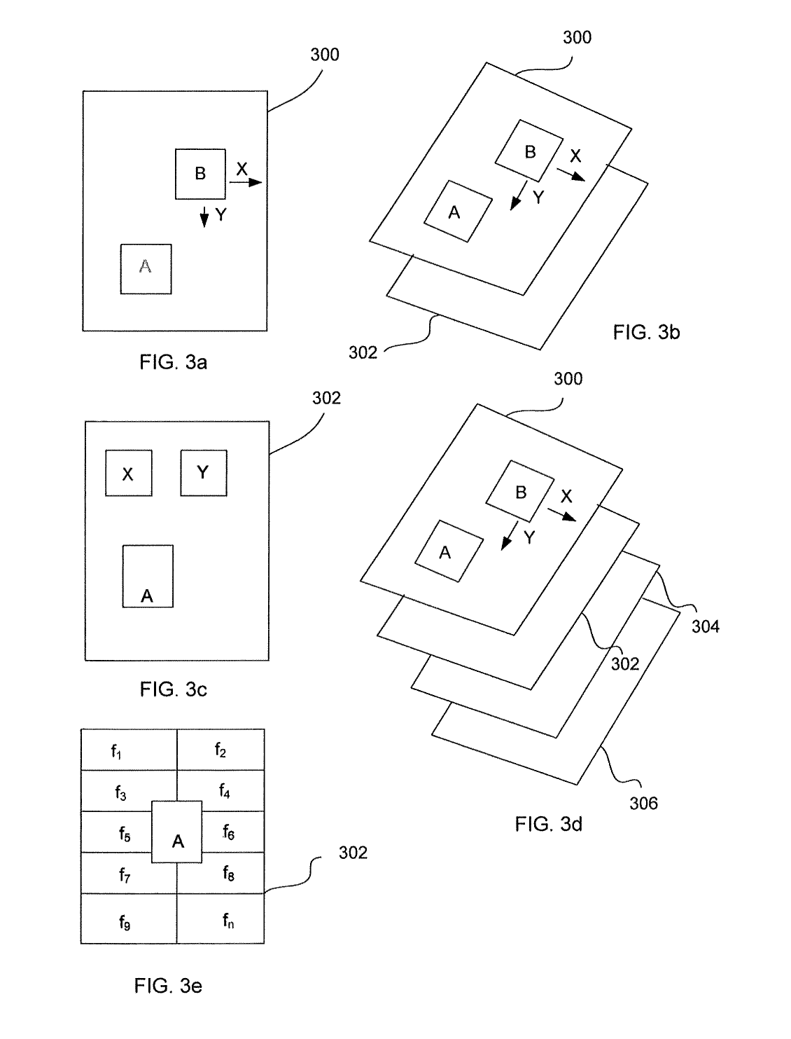

Turning now to FIG. 2 the apparatus is depicted as a mobile telephone 100. The mobile telephone 100 may comprise all or some of the modules described in conjunction with FIG. 1. These modules are therefore not described again. The touch sensitive screen 110 in figure comprises a display area 204 in which folders, applications and other visible content is displayed such that a user can see it. The touch sensitive screen 110 also comprises an area 200 where no content is displayable. This area is used only for recognizing a user touching the touch sensible screen 110 without any interaction with the content displayed on the display area. This non-displayable area may be called a return area and will be described more in detail in conjunction with FIG. 3. In FIG. 2 there is also shown another object having the same function as the return area and is therefore depicted with the same reference numeral 200, namely a return button.

Turning now to FIG. 3 different embodiments of the present invention will be described by way of examples. In FIG. 3a an application 300 is run and is visible in the display area of the touch sensitive screen. The view shown in FIG. 3a may be called an “actual view”, i.e. a view that the user actually sees. In this example the application 300 is a photo album which allows the user to organize its photos, such as A and B; click them for full screen view etc. As is indicated by the arrows X and Y the photos may be moved in 2 dimensions also outside the view depicted in FIG. 3a, i.e.

by flicking to different pages of the photo album. Hidden below the photo album application 300 is a home screen 302 (see FIG. 3b), not at all visible to the user but conceptually it is there, i.e. FIG. 3b is a conceptual view. In context of the present invention the term “home screen” is to be interpreted broadly and may be any page or place where the most used and common applications and/or objects are gathered together. Other terms that may be used interchangeably for such a home screen 302, may be dashboard, desktop, favorite page, short cut page, etc.

If a user now finds an object of interest, in this specific case object A, which he would like to add to the home screen 302 for easy access later he “hard clicks” or “hard presses” this object A. In context of the present invention a hard click is defined by the amount of pressure that is exerted on the touch sensitive screen. If the sensed exerted amount of pressure is above a predetermined threshold it is considered to be a hard click or hard press. In a preferred embodiment of the present invention the exerted pressure must also be above the threshold during a longer than a predetermined period of time. Back now to the example in FIG. 3, where one specific object A has been hard pressed. This hard press triggers navigation in a z-direction perpendicular to the plane of the touch sensitive screen, i.e. the user navigates to the home screen 302 by using navigation in the z-direction. In a preferred embodiment of the present invention also the object A is moving into the z-direction and “follows” the user to the home screen 302 as is shown in the “actual view” of FIG. 3c. In the home screen 302 view of FIG. 3a also objects X and Y are visible. These objects, which may be applications, objects of interest or points of interest have been previously added to the home screen 302. In a conceptual meaning object A has been pressed through the application 300 down to the home screen 302.

Applying a hard press on object A automatically makes the home screen appear together with a symbol of the object A that is subject to be added. The user can drag the object A on the home screen 302 and drop it where he would like it located. Once dropped the home screen 302 disappears and is not longer visible to a user. The user will get back to the previous application 300.

In order to later access the home screen 302 and get access to any of the objects A, X or Y previously stored by the user, the user makes a hard press on the return area or return button 200 (see FIG. 2). The return area was described in conjunction with FIG. 2 and will not be described again. If a dedicated return button is used it might be enough to press the button in order to return to the home screen 302, i.e. in this case no hard press is required.

Note that the example described above in conjunction with FIG. 3a-3c shows how to add a media item or photo A (object of interest) to a dashboard. It would also be possible to add the photo application itself to the dashboard, or a specific view of that application (point of interest). The latter could be done by doing a hard press outside of the A, B photo areas, i.e. the empty space in FIG. 3a.

Turning now to FIG. 3d a preferred embodiment of the present invention will be described. As is evident from FIG. 3d navigation in the z-direction, i.e. the direction perpendicular to the plane of the touch sensitive screen, is done through multiple pages in the z-plane. The different pages in the z-plane may relate to different functions, applications or more than one “home screen”. By using the following example navigation through multiple pages in the z-plane will be described. An application 300, such as a photo application, has a feature that allows the user to send a copy of the photo to another function or application, such as e-mail applications, social media applications, drop box applications, etc. The applications having this feature will enable for example the photo sharing functionality by a hard press on the photo. If the application or function is on the first level, i.e. the home screen 302, the hard press will activate/visualize this page for the user. If the user drops the photo when the page is visible it is sent to the corresponding function. If the user does not drop but continue the hard press the next function, in this case function or application 304, would appear and thereafter function or application 306 and so on. It should be understood that even if levels 302-306 are shown in FIG. 3d it is evident to a person skilled in the art that any number of levels may used and it is a design option.

In another preferred embodiment the speed of the navigation in the z-direction may be controlled in response to the amount of pressure exerted on the touch sensitive screen 110. In order to start the navigation in the z-direction the exerted pressure needs of course be above the predetermined threshold as mentioned above. Thereafter the harder the exerted pressure the faster the navigation. In yet another preferred embodiment of the present invention the home screen 302 has a different functionality than in the embodiment described in conjunction with FIG. 3a-3c. This preferred embodiment will be described in conjunction with FIG. 3e. The view shown in FIG. 3e may be seen as an equivalent to the view shown in FIG. 3d, but with even faster navigation. In this embodiment the display of the home screen 302 is divided into multiple sections (f₁-fn) in response to the navigation in the z-direction, i.e. a hard press. The sections may each represent a function or application performable by the apparatus. This allows for multiple pages (functions or applications) to be displayed simultaneously and thus limits the number of pages that have to be cycled during the z-plane navigation. Furthermore these method steps may be seen such that all functions or applications are organized in a tree structure, which many users using a file structure system are used to and where each level of the tree would be displayed in a single page in the z-plane.

Now consider an object A in the application 300 that visible on the display area of the touch sensitive screen as shown in FIG. 3a. The provider of the application 300 has defined that a “hard press” on the object A shall, as mentioned above, result in a function f being activated. Upon activation of the z-plane navigation, i.e. the user hard presses the object A, the function f will be activated and visualize a page on the display area where each function f₁ to fₙ gets a portion of the display area as shown in FIG. 3e.

If the object A now is dropped on any of the areas that correspond to the functions f₁ to fₙ this will invoke the corresponding function. If the invoked function is an end node of its branch it would typically launch an application, e.g. if the function was e-mail the e-mail application would be launched with the object as its attachment. If the invoked function is an intermediate node typically a new page would be displayed with the next level of functions.

To better understand this function an example with a photo application will be described. A user is browsing photos in a photo application and hard presses on one of the photos displayed in the display area. The hard press will invoke the underlying function which then fades in. In this example the underlying function is a “send to” application where a photo can be sent to a number of different target applications. The finger is still hard pressing the photo which is visible on top of the “send to” application. The user the moves the photo over any of the functions, such as a word processing application or social media application, and holds it still there for at least 0.5 seconds. The word processing application or social media application is then visualized and the user may drop the photo in order to share it with this application. It should be understood that instead of dropping the photo over an application it might be dropped into a folder. The time for triggering the visualization of the application or the folder may be set freely depending on user requirements and does not have to be 0.5 seconds.

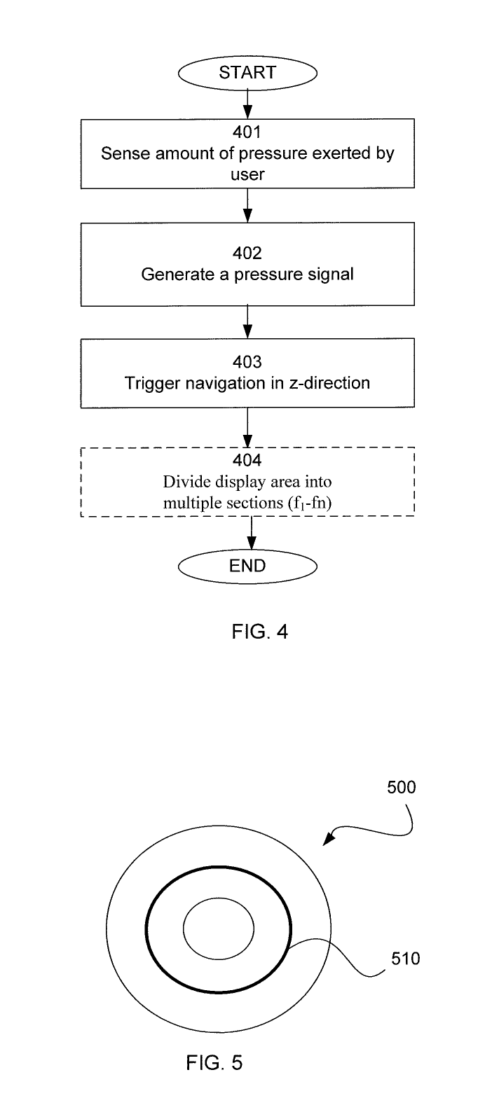

Turning now to FIG. 4, the method according to present invention will be summarized. In a first step 401 the method for navigating on the touch sensitive screen 110 senses the amount of pressure exerted on the touch sensitive screen 110. In step 402 a pressure signal is generated that is indicative of the exerted amount of pressure. If the pressure signal is above a predetermined threshold the navigation in the z-direction is triggered in step 403, i.e. in a direction perpendicular to the plane of the touch sensitive screen. In a preferred embodiment step 403 is only performed if the pressure signal is above the threshold during a predetermined period of time. The navigation in the z-direction may be performed according to any of the examples described above.

As an optional step 404 the display area of the home screen 302 may be divided into multiple sections f₁-fn in response to the navigation in the z-direction. As mentioned above each section represents a function or application that is performable by the apparatus 100.

FIG. 5 schematically shows one example of a computer program product 500 comprising computer readable means 510. On this computer readable means 510, a computer program can be stored, which computer program, when run on the processor 120 of the apparatus 100, can cause the apparatus 100 to execute the method according to various embodiments described in the present disclosure. In this illustrative example, the computer program product is an optical disc, such as a CD (compact disc), a DVD (digital versatile disc) or a blue-ray. However, in preferred embodiments the computer-readable means can also be solid state memory, such as flash memory or a software package (also sometimes referred to as software application, application or app) distributed over a network, such as the Internet.

Although the present invention has been described above with reference to specific embodiments, it is not intended to be limited to the specific form set forth herein. Rather, the invention is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1-16. (canceled)

17. A method for navigating on a touch sensitive screen of an apparatus, the method comprising:
sensing the amount of pressure exerted on the touch sensitive screen,
generating a pressure signal indicative of the exerted amount of pressure,
triggering navigation in a z-direction perpendicular to the plane of the touch sensitive screen if the pressure signal is above a predetermined threshold, and
moving an object of interest into the z-direction if the pressure exerted on the touch sensitive screen was exerted on the object of interest.

18. The method of claim 17, wherein the method further comprises triggering navigation in the z-direction if the pressure signal is above the predetermined threshold during a time period that is longer than a predetermined time.

19. The method of claim 17, wherein the method further comprises controlling the depth of the navigation in the z-direction in response to the amount of time the pressure signal has been above the predetermined threshold.

20. The method of claim 17, wherein the method further comprises controlling the speed of the navigation in the z-direction in response to the amount of pressure exerted on the touch sensitive screen above the predetermined threshold.

21. The method of claim 17, wherein the method further comprises disabling navigation in the z-direction in response to the pressure signal falling below the predetermined threshold.

22. The method of claim 17, wherein the method further comprises dividing a display area of the touch sensitive screen into multiple sections in response to the navigation in the z-direction, each of said sections representing a function or application performable by the apparatus.

23. An apparatus comprising,
a touch sensitive screen having a display area,
a pressure sensor,
a processor, and
a memory for storing a computer program comprising computer program code that, when run in the processor, causes the apparatus to:
sense the amount of pressure exerted on the touch sensitive screen;
generate a pressure signal in response to sensed pressure;
trigger navigation in a z-direction perpendicular to the plane of the touch sensitive screen if the pressure signal is above a predetermined threshold; and
move an object of interest into the z-direction if the pressure exerted on the touch sensitive screen was exerted on the object of interest.

24. The apparatus of claim 23, wherein the memory and the computer program are configured to further cause the apparatus to trigger navigation in the z-direction if the pressure signal is above the predetermined threshold during a time period that is longer than a predetermined time.

25. The apparatus of claim 23, wherein the memory and the computer program are configured to further cause the apparatus to control the depth of the navigation in the z-direction in response to the amount of time the pressure signal has been above the predetermined threshold.

26. The apparatus of claim 23, wherein the memory and the computer program are configured to further cause the apparatus to control the speed of the navigation in the z-direction in response to the amount of pressure exerted on the touch sensitive screen above the predetermined threshold.

27. The apparatus of claim 23, wherein the memory and the computer program are configured to further cause the apparatus to disable navigation in the z-direction in response to the pressure signal falling below the predetermined threshold.

28. The apparatus of claim 23, wherein the memory and the computer program are configured to further cause the apparatus to divide a display area of the touch sensitive screen into multiple sections in response to the navigation in the z-direction, each of said sections representing a function or application performable by the apparatus.

29. A non-transitory computer-readable medium comprising, stored thereupon, a computer program comprising computer program code that, when run in a processor of an apparatus having a touch sensitive screen with a display area and further having a pressure sensor, causes the apparatus to:
sense the amount of pressure exerted on the touch sensitive screen;
generate a pressure signal in response to sensed pressure;
trigger navigation in a z-direction perpendicular to the plane of the touch sensitive screen if the pressure signal is above a predetermined threshold; and
move an object of interest into the z-direction if the pressure exerted on the touch sensitive screen was exerted on the object of interest.
